(19) United States
(12) Patent Application Publication
(10) Pub. No.: US 2025/0103665 A1
(43) Pub. Date: Mar. 27, 2025

(54) TRENDING PROSPECTING FOR DYNAMIC CONTENT RECOMMENDATION

(71) Applicant: Yahoo Ad Tech LLC, New York, NY (US)

(72) Inventors: Oren S. Somekh, Kfar-Netter (IL); Omer Duvdevany, Tel-Aviv (IL); Evgeny Segal, Ashkelon (IL); Naama Haramaty-Krasne, Kfar-Yehoshua (IL); Eliran Abutbul, Kiryat Ata (IL)

(21) Appl. No.: 18/372,729

(22) Filed: Sep. 26, 2023

(51) Int. Cl. G06F 16/9536

(52) U.S. Cl. CPC G06F 16/9536

(57) ABSTRACT

One or more systems and/or methods for providing trending prospecting for dynamic content recommendation are provided. A model is trained to predict eligibility scores of users to content items based upon popularity of the content items and similarities of the users with other users that have engaged with the content items. As part of training, positive and negative events are input into the model. For each user and content item pair, the model generates an eligibility score corresponding to a ratio between a number of users that are similar to a user and have engaged with the content item to a number of users that are similar to the user and are part of a user population represented by the positive events and the negative events. The eligibility scores are used to generate and train the model. The model is used to select and provide content items to computing devices.

### BACKGROUND

A content serving platform provides an architecture through which content items of content providers can be provided to computing devices of users. The content items may relate to consumer goods (e.g., lawn mowers, smart speakers, cars, movies, etc.), services (e.g., a lawn care service, a plumbing service, a vacation planning service, a streaming service, etc.), locations, and/or a variety of other entities. The content items may be represented or described through text, images, videos, social network feed posts, etc. (e.g., a photo and description of a pair of shoes, along with a link to view/purchase the shoes from a merchant). The content items may be displayed through websites, applications, emails, social network feeds, text messages, etc. In this way, the content serving platform can select a content item that may be relevant to a user (e.g., a photo and description of running shoes for a user training for a marathon), and provides the content item to a computing device of the user for display.

### SUMMARY

In accordance with the present disclosure, one or more computing devices and/or methods for providing trending prospecting for dynamic content recommendation are provided. A content serving platform utilizes various models to select content items to provide to users, such as text, images, and/or videos relating to products, services, and/or other entities. In order to improve operation of the content serving platform, such as to more accurately and precisely select content items that will be of interest to users, a model is generated and trained to predict eligibility scores of users to content items (e.g., a lookalike model trained using a machine learning based scoring algorithm). The model is trained to predict the eligibility scores based upon popularity of the content items and similarities of the user with other users that have engaged with the content items. In this way, the model can be used for trending prospecting so that the content serving platform can support content providers that have little to no logged history of what content items have been provided to and/or engaged with by users.

As part of training, positive and negative events are input into the training algorithm. The positive events are input from an external content provider feed (e.g., a data feed from a content provider, which indicates whether and how users interacted with content items of the content provider such as through a website of the content provider), and may correspond to positive engagement by users such as through the website of the content provider (e.g., a user adding a product to an online shopping cart, the user purchasing the product, etc.). The negative events correspond to a negative sample (e.g., negative samples from a native impression feed of the content serving platform such as where users ignored a content item).

For each user and content item pair, the model generates an eligibility score corresponding to a ratio between a number of users that are similar to a user and have engaged with the content item to a number of users that are similar to the user and are part of a user population represented by the positive events and the negative events. The eligibility scores are used to generate and train the model. Once trained, the content serving platform utilizes the model to select and provide content items to computing devices for display to users.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for providing trending prospecting for dynamic content recommendation.

FIG. 5A is a component block diagram illustrating an example system for providing trending prospecting for dynamic content recommendation.

FIG. 5B is a component block diagram illustrating an example system including a model trainer.

FIG. 6 is a component block diagram illustrating an example system for providing trending prospecting for dynamic content recommendation.

FIG. 7 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

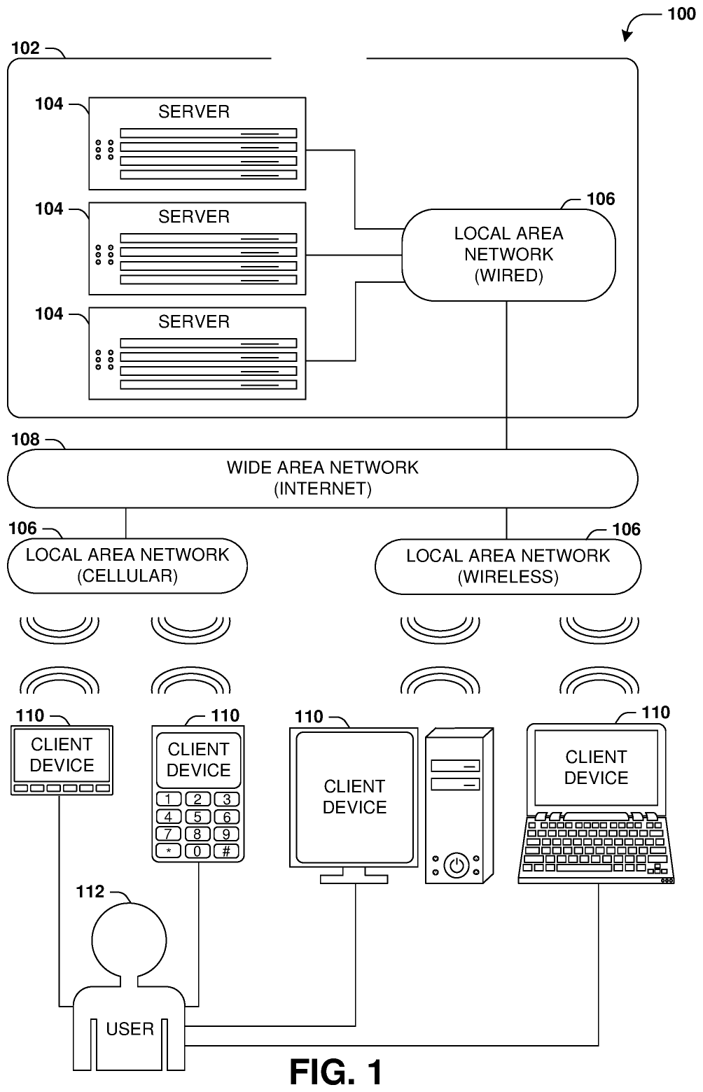

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ different architectures, may be compliant or compatible with differing protocols and/or may interoperate within the local area network 106. Additionally, a variety of local area networks 106 may be interconnected; e.g., a router may provide a link between otherwise separate and independent local area networks 106.

In scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

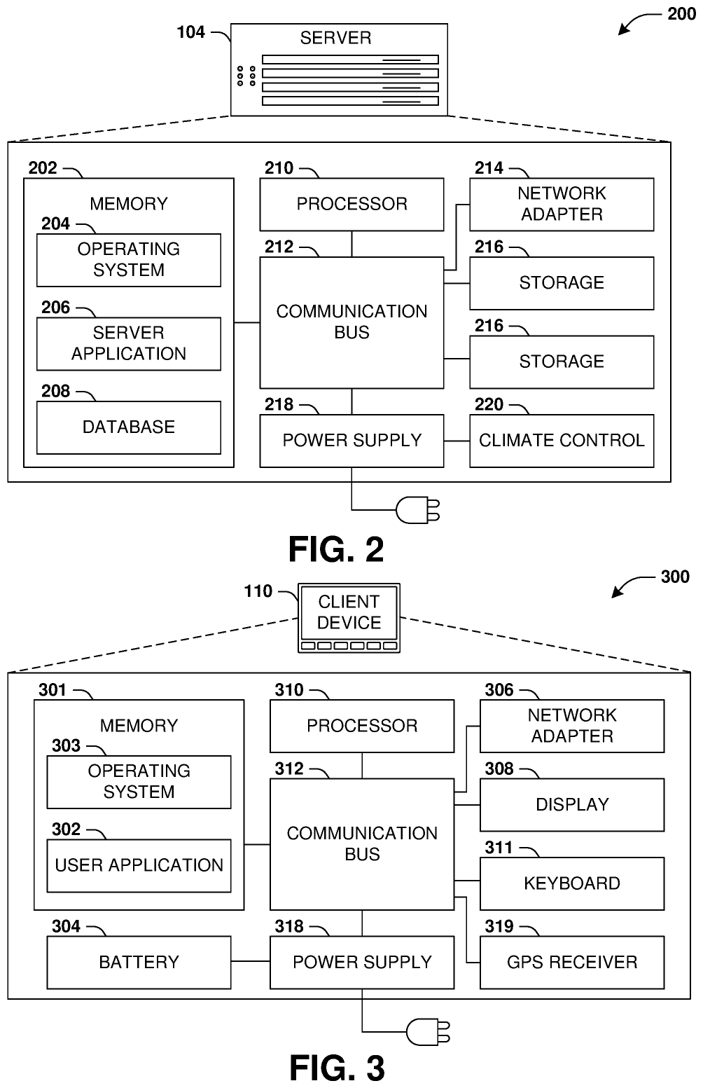

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic architecture diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

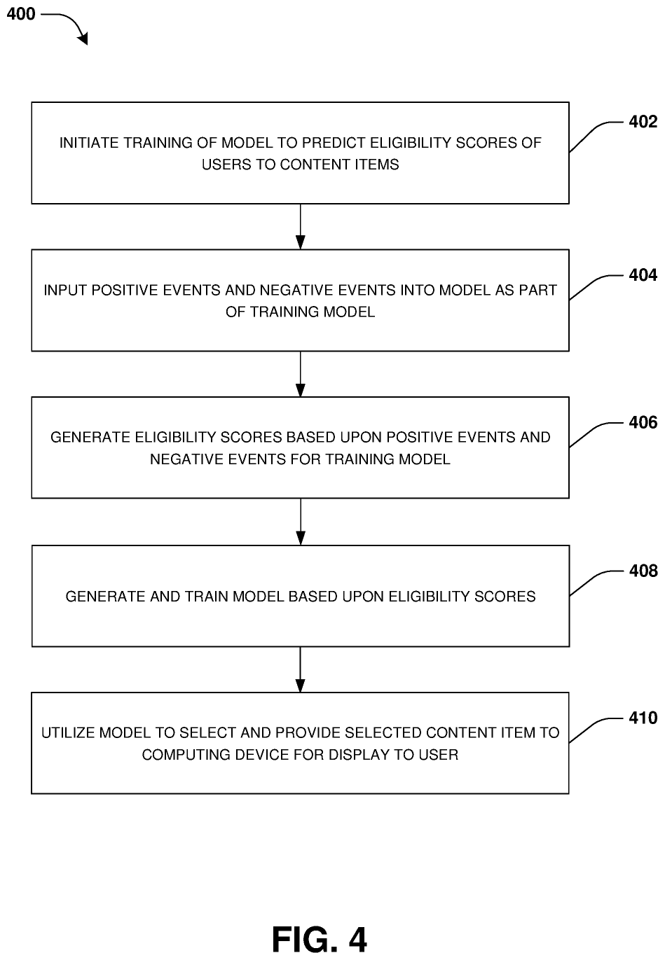

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

### 2. Presented Techniques

One or more systems and/or techniques for providing trending prospecting for dynamic content recommendation are provided. A content serving platform serves users with content items, which may be displayed through websites (e.g., a content item constructed to resemble surrounding webpage content), applications, emails, text messages, notifications, social network feeds, and/or other user interfaces displayed on computing devices. The content items may correspond to products, services, and/or other entities associated with content providers (e.g., laptops and tablets sold by an electronic company, lawn equipment sold by a lawn equipment manufacturer, music and movie streaming services of a streaming service provider, etc.). At any given time, there may be hundreds of thousands of content items available to display to users.

The content items may be selected through a real-time auction hosted by the content serving platform. A content provider such as a merchant may provide a catalog to the content serving platform. The catalog could include millions of products available through the merchant, which may be displayed as content items to users by the content serving platform. The content serving platform may automatically create a personalized experience for a user accessing a website by choosing products from the catalog that may be of interest to the user. The products may be used to generate content items that can be displayed through the website to the user. The content items that are selected to be presented to the user may be selected as part of the real-time auction. The real-time auction takes into account budget considerations and targeting considerations of the merchant and/or the products of the catalog. A product from the catalog with the highest bid is selected and provided as a content item to the user by the content serving platform.

Campaigns may be used by the content serving platform as part of the selection process. One type of campaign is a retargeting campaign. The retargeting campaign is used to serve users that already showed an interest in a content item at a content provider website (e.g., showed an interest in a particular videogame by reading a description of the videogame through a website of an online merchant). When the user visits a website supported by the content serving platform, the content item (e.g., a description and link to purchase the videogame) may be displayed to the user as a retargeted content item. Another type of campaign is a prospecting campaign. The prospecting campaign has the goal of expanding an audience of a content provider by presenting content items to users that have not directly interacted with the content items. Various models (e.g., machine learning models) may be used to leverage additional signals such as search history and location of a user in order to predict what content items may be relevant and interesting to the user.

The techniques provided herein improve operation of the content serving platform by providing a trending prospecting approach that is less restrictive and more comprehensive than existing prospecting techniques. The disclosed trending prospecting approach enables the content serving platform to support new content providers. The content serving platform can utilize the disclosed trending prospecting approach to match trending products to users by learning user-product tendency from logged events in a content provider website (e.g., positive events from an external content provider feed) and random negative event samples. Scoring takes into account popularity of content items (e.g., popularity of different videogames) and similarity of a user to other users that have engaged with a content item (e.g., a similarity in age and gender features of a user to other users who have purchased a roleplaying videogame). In this way, the content serving platform can expand the audience for a content provider that has little or no logged events with the content serving platform, which also makes onboarding new content providers easier. That is, the content serving platform can implement the disclosed trending prospecting approach in order to serve new content providers (and new content items) that may have no event history with the content serving platform logged data feeds.

The trending prospecting approach involves the training of a model (e.g., a lookalike model) to predict eligibility scores of a user to a certain content item (e.g., an indication of how likely the user will have an interest in a product). Given a user and a product (a content item), the eligibility score takes into account multiple factors such as a popularity of the product and a similarity of the user to other users that have already engaged with the product (e.g., users with the same or similar gender features and age that have purchased or added to cart the product). This may be captured by a machine learning based scoring algorithm, and thus the lookalike model can, in some embodiments leverage the algorithm (e.g., a machine learning based scoring algorithm or any other machine learning based scoring algorithm) to take advantage of collaborative filtering (e.g., the filling of information gaps due to sparsity issues by revealing hidden patterns within data considered by the lookalike model). In particular, a user that has already engaged with a product will contribute to the learning process of all users and products that share similar user features. A cost per action threshold may be set (e.g., up to 10%) in order to broaden the reach by a content provider to new users.

The model (the lookalike model) uses the machine learning based scoring algorithm to take into account age, gender, and/or other demographics as user features. The model also uses the machine learning based scoring algorithm to take into account product features such as a content item id (product id), a content item set id (product-set id), and a content provider id. Events (e.g., displaying a content item, a user ignoring a content item, a user purchasing a product depicted or recommended by a content item, etc.) that involve users with unknown age and/or gender values may be ignored, in some embodiments. Instead of the machine learning based scoring algorithm consuming click and skip data (e.g., a click as a positive event and a skip as a negative event) as input to predict a click through rate, the machine learning based scoring algorithm is altered to accept new inputs in order to generate user-product eligibility scores. In the context of the model (the lookalike model) the machine learning based scoring algorithm is now trained with new/different inputs, which can be used to consider content providers with little to no logged event history by using feeds of the content providers mixed with negative random samples from an impression feed to generate eligibility scores (or user-product tendency scores). The positive events relate to purchase, add to cart events, view events, and/or a variety of other events that are obtained from the external content provider feed of the content provider. In order to improve the efficiency of training, the top N popular content items (e.g., 1000 most popular products) are used for training. Because the external content provider feed does not include negative events, a random sample of M negative events (e.g., 2000) (e.g., negative events from a native impression feed, a simulation of random negative events, etc.) of the content serving platform for training. By modifying the machine learning based scoring algorithm to take into account these new inputs, the machine learning based scoring algorithm can differentiate between users that have engaged with a certain content item in the external content provider feed to users of a general population picked by the random sample of M negative events.

During training of the model, input data sources are joined to create a user-product feed. The top-N popular content items (e.g., the top 1000 most popular products), along with users that have engaged with the top-N popular content items are derived from the user-product feed. Positive events for the top-N popular content items along with the random negative samples are used to train the machine learning based scoring algorithm in order to generate the Lookalike model. In some embodiments, the model may be updated periodically (e.g., daily) with popular content items of the prior day or any other timespan. Training the machine learning based scoring algorithm with the new inputs changes the semantics of the resulting offset score (eligibility score). Given a user and a product, the offset score (eligibility score) corresponds to a ratio between a number of users similar to a user (e.g., users having the same age and gender as a user that will be provided with one or more content items by the content serving platform) and that have engaged with the product as identified by the external content provider feed to the number of users similar to the user in the general population (e.g., users served by the content serving platform).

In some embodiments, an eligibility score is defined as Su, ˜#pos/#pos+#neg=|pos (u, p)|/|pos (u, p)|+|neg(u)|, where u is a user and p is a product (content item). |pos (u, p)| is the number of users like user u that engaged with product p and |ne(u)| is the number of users like user u in the negative random sample. The eligibility score Su, corresponds both to the popularity of product p (as captured by |pos (u, p)|) and a lookalike level of user u to the users that already engaged with product p (as captured by the ratio). Since users are represented by user features, audience expansion is less restricted than other prospecting types that require user id or bCookie.

Because the eligibility score may be between 0 and 1 (or any other range of values), an eligibility score threshold is set so that a binary decision can be made as to whether a user is eligible or non-eligible to be presented by a content item of the content serving platform. If the eligibility score exceeds the eligibility score threshold, then the user is determined to be eligible. If the eligibility score does not exceed the eligibility score threshold, then the user is determined to be non-eligible.

The value of the eligibility score threshold can be changed for flexibility in how content items are delivered/served to users. A content provider can choose to lower the eligibility score threshold in order to increase delivery and expose content items of the content provider to a wider audience of users. Alternatively, the content provider can raise the eligibility score threshold in order to optimize performance and focus delivery of content items to users with higher eligibility scores that are more likely to engage with the content items (e.g., more likely to purchase a product or service recommended by a content item).

The eligibility score threshold may be set by defining the percentage of the user population that will be considered eligible. In order to achieve this, after each time the model is trained, scores are generated for a new test sample of users of size n (e.g., n=20k). For each user in the test sample, available content items of a content provider are scored. The highest eligibility score for each user is retained such as in a histogram portraying a distribution of maximal eligibility scores in the user population. Given a threshold, a percentage of users that will be considered as eligible is checked (e.g., how many users that have a maximal score above the threshold). Using this mechanism, a content provider can set the percentage of eligible users for trending prospecting of content items of the content provider. For example, if the content provider sets a defined threshold that corresponds to 5% of the user population, then the threshold is selected so that 5% of the test sample users will have eligibility scores higher than the threshold for some content item of the content item provider. This gives the content provider more control over the quality-quantity trade off of trending prospecting (e.g., reaching a larger audience vs a smaller audience of users more likely to engage with a content item).

After setting the eligibility score threshold, the trained model is published as an input for content item serving by the content serving platform. The allocation of content items to each content item group in the model may be based upon a content item group spending in a prior day. Content item groups with higher budgets will have more content items in the model. A minimum limit is set to ensure that no content item group suffers from starvation where content items of a particular content item group are rarely provided to users. In some embodiments, trending prospecting content items (e.g., content items for which the model determines that a user is eligible to be provided with such content items) are also competing (e.g., bidding) in other internal preliminary auctions of the content serving platform before the content serving platform selects one or more final content items to provide to a user. The lookalike model is used for each incoming user u to score the top products (a product p) and send those having a score S(u,p)>threshold to compete in an internal auction before sending the winners to a final auction of the content service system. The threshold is set according to the percentage of users to which the content provider wants to expose its products.

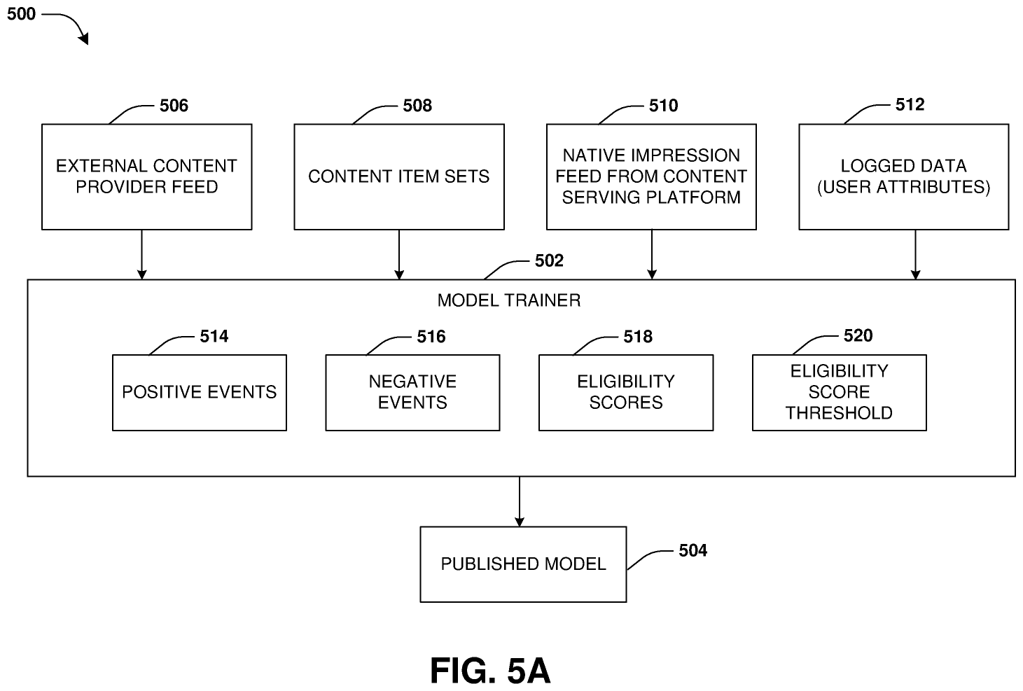

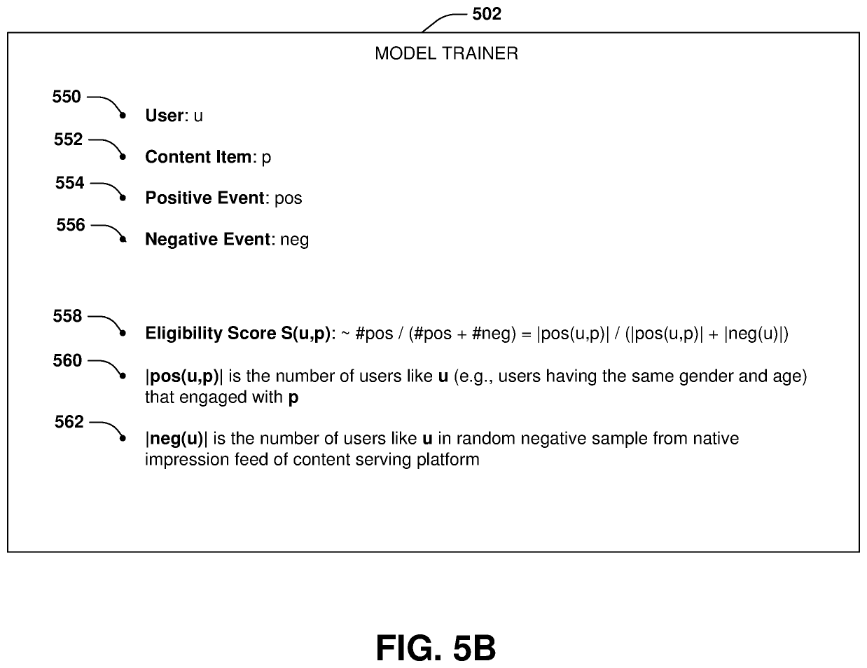

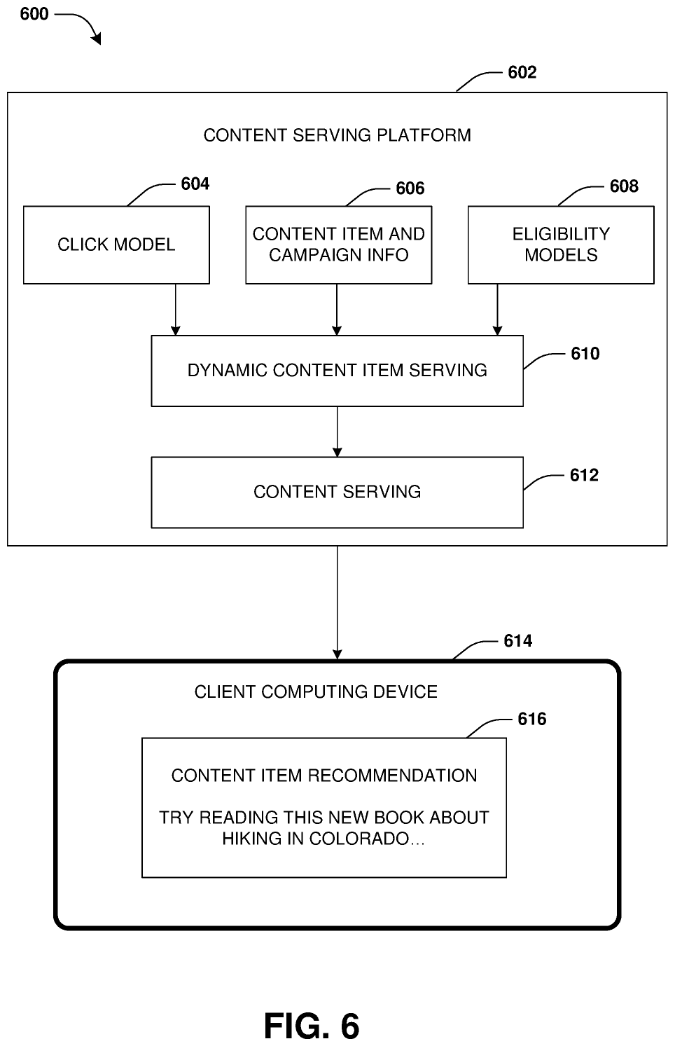

FIG. 4 is a flow chart illustrating an example method 400 for providing trending prospecting for dynamic content recommendation, which is described in conjunction with system 500 of FIGS. 5A and 5B and system 600 of FIG. 6. A model trainer 502 is configured to train a model 504 to predict eligibility scores of users to content items based upon popularity of the content items and similarity of the user to other users that have engaged with the content items such as through a website of a content provider. In some embodiments, the model trainer 502 utilizes an machine learning based scoring algorithm to train a lookalike model by modifying the machine learning based scoring algorithm to accept new inputs such as positive events 514 relating to purchases and add to cart events from an external content provider feed 506 and negative events 516 relating to a random negative sample. In this way, the training of the model 504 by the model trainer 502 is initiated during operation 402 of method 400.

As part of the model trainer 502 training the model 504, the model trainer 502 selects content items from content item sets 508, which are used to train the model 504. A content item may be represented by content item features that include a content item ID of the content item, a content item set ID of a content item set that includes the content item, and a content provider ID of a content provider of the content item (e.g., a merchant that sells a product represented by the content item).

The model trainer 502 may utilize logged data 512 associated with users interacting with content (e.g., a user visiting a website that utilizes the content serving platform 602 to display content items, a user visiting a website of a content provider, etc.) to identify users represented by user features such as age, gender, and/or other demographic features. The model trainer 502 can utilize the user features in order to identify users that are similar, such as users that have a similar or same age and/or gender features as a particular user.

During operation 404 of method 400, the positive events 514 and the negative events 516 are input into the model 504 (e.g., input into the machine learning based scoring algorithm for generating and training the model 504 by the model trainer 502). The positive events 514 are input from the external content provider feed 506 of a content provider, and may correspond to positive user engagement with content items through a website or app of the content provider (e.g., a user adding a product or service to a cart through a shopping website of a merchant, the user purchasing the product or service, etc.). In some embodiments, the negative events 516 are input from the native impression feed 510 from the content serving platform 602 (e.g., events where users did not interact with content items provided by the content serving platform 602 to the users). It may be appreciated that the negative events 516 can be derived in a variety of different manners, such as through a simulation of negative events or obtained from a variety of different data sources.

During operation 406 of method 400, the model trainer 502 trains the model 504 by generating eligibility scores 518. In some embodiments, an eligibility score may be between 0 and 1, or any other range of values. The eligibility score may be assigned to a user content item pair that corresponds to a user (e.g., a user visiting a website through which content items may be served by the content serving platform 602) and a content item. The larger the value of the eligibility score, the more eligible the user is to be shown the content item. The eligibility score corresponds to a ratio between a first number of users that are similar to that user and that have engaged with the content item (e.g., a number of users that have the same/similar age and/or gender, and have purchased or added to cart the content item, as indicated by the positive events 514 from the native impression feed 510) to a second number of users that are similar to the user and are part of a user population represented by the positive events 514 and the negative events 516. The second number of user correspond to the first number of users that are similar to the user and that have engaged with the content item (e.g., the positive events 514) in addition to a number of users that are similar to the user in the random negative sample.

FIG. 5B illustrates an embodiment of the model trainer utilizing the model 504 during training to generate an eligibility score 558. The eligibility score 558 is generated for a user content item pair of a user u 550 and a content item p 552. A positive event 554 is represented by pos and a negative event 556 is represented by neg. Accordingly, the eligibility score 558 is defined as Su, ˜#pos/#pos+#neg=|pos (u, p)|/|pos (u, p)|+|neg(u)|. |pos (u, p)| 560 is the number of users like user u 550 that engaged with content item p 552. |ne(u)| 562 is the number of users like user u 550 in the negative random sample (e.g., negative random samples from the native impression feed 510 of the content serving platform 602).

Returning to FIG. 5A, an eligibility score threshold 520 may be set for the model 504. If an eligibility score exceeds the eligibility score threshold 520 (e.g., an eligibility score greater than 0.65), then the user u 550 is considered eligible to be provided with content item p 552. In this way, the eligibility score threshold 520 is defined for determining whether users are eligible or ineligible to be provided with content items. The eligibility score threshold 520 may be set based upon a percentage of a target user population that is to be considered eligible for being provided with a content item. The eligibility score threshold 520 may be modified to optimize performance so that the content item is provided to users that are more likely to engage with the content item. The eligibility score threshold 520 may be adjusted (e.g., decreased) to increase a pool of eligible users so that the pool of eligible users will now include additional eligible users with lower eligibility scores than eligible users that were in the pool before the adjustment of the eligibility score threshold 520. The eligibility score threshold 520 may be adjusted (e.g., increased) to decrease the pool of eligible users so that the pool of eligible users will now exclude previously eligible users with lower eligibility scores than the adjusted eligibility score threshold 520 (e.g., users with lower eligibility scores than eligibility score of remaining eligible users within the pool after adjustment of the eligibility score threshold 520).

In some embodiments of defining the eligibility score threshold 520, scores for a test sample of users are produced in response to training the model 504 (e.g., the model 504 may be periodically trained for test samples of users). For each user within the test sample of users, content items of a content provider are scored with eligibility scores. A distribution of highest eligibility scores are stored for each user, such as within a histogram or other structure/data representation. A threshold and the distribution of highest eligibility scores are used to check a percentage of users that will be considered eligible to be provided with the content item based upon the users having eligibility scores above the threshold. A percentage of eligible users for the content item is set based upon the percentage of users that will be considered eligible and/or the threshold. In some embodiments, a specified threshold may be received from a content provider. The specified threshold may correspond to the percentage of users. The threshold may be selected so that the percentage of users will have eligibility scores higher than the threshold for the content item of the content provider.

During operation 408 of method 400, the model trainer 502 utilizes the eligibility scores 518, eligibility score threshold 520, the positive events 514, the negative events 516, the user attributes/features, and the content item attributes/features in order to generate and train the model 504. In some embodiments, the model 504 may be periodically trained, such as daily based upon a current list of popular content items from the prior day. In some embodiments, the model trainer 502 may be configured to publish the model 504. In some embodiments, the model 504 is bound by a set number of content items (e.g., once trained and published, the model 504 may be bound to 3,500 or some other number of content items selected based upon various serving limitations). Content items, of content item groups, may be allocated in the model 504 based upon prior spending associated with recommending the content items. For example, a first content item group with a larger budget (e.g., larger spend in the prior day) may have more content items allocated within the model compared to a second content item group with a smaller budget (e.g., smaller spend in the prior day). To avoid starvation, a minimum limit may be set for each content item group so that a minimum amount of content items from each content item group are allocated within the model irrespective of prior spending or budget.

After training, the model 504 is published for use by the content serving platform 602 for serving content items to computing devices of users, as illustrated by FIG. 6. During operation 410 of method 400, the model is utilized by the content serving platform 602 to select and provide a content item to a computer device for display to a user. For example, the content serving platform 602 utilizes a click model 604, content item and campaign information 606, and eligibility models 608 (e.g., the model 504 such as a lookalike model trained using an machine learning based scoring algorithm for trending prospecting) for dynamic content item serving 610.

When a user of a client computing device 614 accesses a website (or application) for which the content serving platform 602 is enabled, the content serving platform 602 receives contextual information, such as user features about the user (e.g., age, gender features, browsing history, etc.) and features of the website being accessed by the client computing device 614 (e.g., in order to generate a content item with features that match website content, such as matching color and style). The dynamic content item service 610 utilizes the eligibility models 608 to process user features of the user and content item features from the content item and campaign information 606 in order to determine whether the user is eligible to be provided with certain content items. The dynamic content item service 610 may also utilize the click model 604 to determine whether the user will click on the content items. The content items for which the dynamic content item service 610 has determined that the user is eligible are used by content serving functionality 612 of the content serving platform 602 in order to select and provide one or more content items to the client computing device 614 for display to the user. The content serving functionality 612 may involve an auction that is performed where the content items bid on the opportunity to be provided to the client computing device 614. In an example, a content item recommendation 616 of a content item having a winning bid may be created by the content serving platform 602, and is provided to the client computing device 614 for display to the user.

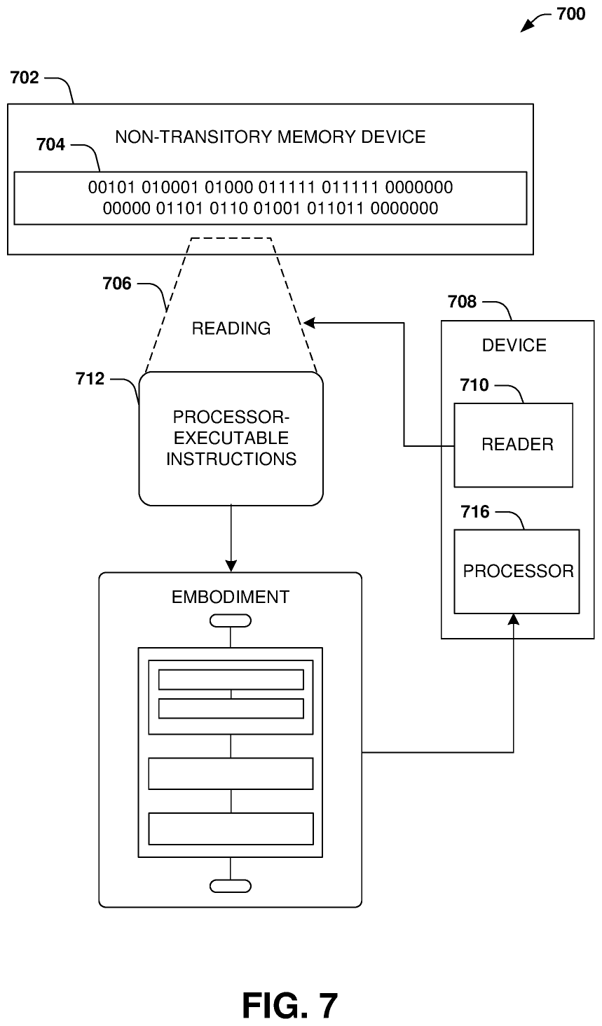

FIG. 7 is an illustration of a scenario 700 involving an example non-transitory machine readable medium 702. The non-transitory machine readable medium 702 may comprise processor-executable instructions 712 that when executed by a processor 716 cause performance (e.g., by the processor 716) of at least some of the provisions herein. The non-transitory machine readable medium 702 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 702 stores computer-readable data 704 that, when subjected to reading 706 by a reader 710 of a device 708 (e.g., a read head of a hard disk drive, or a read operation invoked on a solid-state storage device), express the processor-executable instructions 712. In some embodiments, the processor-executable instructions 712, when executed cause performance of operations, such as at least some of the example method 400 of FIG. 4, for example. In some embodiments, the processor-executable instructions 712 are configured to cause implementation of a system, such as at least some of the example system 500 of FIG. 5 and/or at least some of the example system 600 of FIGS. 6A-6C, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In some embodiments, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method executing on a processor of a computing device that causes the computing device to perform operations comprising:
training a model to predict eligibility scores of users to content items based upon popularity of the content items and similarities of the users with other users that have engaged with the content items, wherein the training includes:
inputting positive events and negative events into the model, wherein the positive events are input from an external content provider feed and relate to positive user engagement with a content item, and wherein the negative events correspond to a random negative sample;
generating an eligibility score corresponding to a ratio between a first number of users that are similar to a user and have engaged with the content item to a second number of users that are similar to the user and are part of a user population represented by the positive events and the negative events; and
generating and training the model based upon the eligibility score; and
utilizing the model to select and provide a selected content item to a computing device for display to the user.

2. The method of claim 1, comprising:
defining an eligibility score threshold used to determine whether the user is eligible or ineligible to be provided with the content item.

3. The method of claim 2, comprising:
setting the eligibility score threshold based upon a percentage of a target user population that will be considered eligible.

4. The method of claim 2, comprising:
modifying the eligibility score threshold to optimize performance and provide the content item to users that are more likely to engage with the content item.

5. The method of claim 2, wherein the defining the eligibility score threshold comprises:
in response to training the model, producing scores for a test sample of users;
for each user within the test sample of users, scoring content items of the content provider with a plurality of eligibility scores;
storing a distribution of highest eligibility scores, of the plurality of eligibility scores, for each user;
utilizing a threshold and the distribution to determine a percentage of users that will be considered eligible based upon the users having eligibility scores above the threshold; and
defining the eligibility score threshold based upon at least one of the threshold or the percentage of users that will be considered eligible.

6. The method of claim 5, comprising:
receiving a specified threshold from the content provider, wherein the specified threshold corresponds to the percentage of users; and
selecting the threshold so that the percentage of users will have eligibility scores higher than the threshold for the content item of the content provider.

7. The method of claim 2, comprising:
adjusting the eligibility score threshold to increase a pool of eligible users to include additional eligible users with lower eligibility scores than eligible users that were in the pool before adjustment of the eligibility score threshold.

8. The method of claim 2, comprising:
adjusting the eligibility score threshold to decrease a pool of eligible users to exclude eligible users with lower eligibility scores than remaining eligible users within the pool after adjustment of the eligibility score threshold.

9. A non-transitory machine readable medium having stored thereon processor-executable instructions that when executed cause performance of operations, the operations comprising:
training a model to predict eligibility scores of users to content items based upon popularity of the content items and similarities of the users with other users that have engaged with the content items, wherein the training includes:
inputting positive events and negative events into the model, wherein the positive events are input from an external content provider feed and relate to positive user engagement with a content item, and wherein the negative events correspond to a random negative sample;
generating an eligibility score corresponding to a ratio between a first number of users that are similar to a user and have engaged with the content item to a second number of users that are similar to the user and are part of a user population represented by the positive events and the negative events; and
generating and training the model based upon the eligibility score; and
utilizing the model to select and provide a selected content item to a computing device for display to the user.

10. The non-transitory machine readable medium of claim 9, wherein the operations comprise:
bounding the model by a set number of content items; and
allocating content items, of content item groups, in the model based upon prior spending associated with recommending the content items.

11. The non-transitory machine readable medium of claim 10, wherein a first content item group with a larger budget has more content items allocated within the model than a second content item group with a smaller budget.

12. The non-transitory machine readable medium of claim 10, wherein a minimum limit is set for each content item group to avoid starvation.

13. The non-transitory machine readable medium of claim 9, wherein the operations comprise:
identifying users that are similar to the user based upon the users and the user having similar user features.

14. The non-transitory machine readable medium of claim 9, wherein the operations comprise:
identifying users that are similar to the user based upon the users and the user having the same gender and age.

15. The non-transitory machine readable medium of claim 9, wherein the second number of users, that are similar to the user and are part of the user population, correspond to the first number of users that are similar to the user and have engaged with the content item in addition to a number of users similar to the user in the random negative sample from a native impression feed of a content serving platform.

16. The non-transitory machine readable medium of claim 9, wherein the positive events include purchase events and add to cart events.

17. A computing device comprising:
a processor; and
memory comprising processor-executable instructions that when executed by the processor cause performance of operations, the operations comprising:
training a model to predict eligibility scores of users to content items based upon popularity of the content items and similarities of the users with other users that have engaged with the content items, wherein the training includes:
inputting positive events and negative events into the model, wherein the positive events are input from an external content provider feed and relate to positive user engagement with a content item, and wherein the negative events correspond to a random negative sample from a content serving platform;
generating an eligibility score corresponding to a ratio between a first number of users that are similar to a user and have engaged with the content item to a second number of users that are similar to the user and are part of a user population represented by the positive events and the negative events; and
generating and training the model based upon the eligibility score; and
utilizing the model to select and provide a selected content item to a computing device for display to the user.

18. The computing device of claim 17, wherein the user is represented by user features that include an age feature and a gender feature.

19. The computing device of claim 17, wherein the content item is represented by content item features that include a content item ID, a content item set ID, and a content provider ID.

20. The computing device of claim 17, wherein the operations comprise:
defining an eligibility score threshold used to determine whether the user is eligible or ineligible to be provided with the content item.
